(19) United States
(12) Patent Application Publication
(10) Pub. No.: US 2015/0278870 A1
(43) Pub. Date: Oct. 1, 2015

(54) TRANSACTION PROCESSING AND MANAGEMENT BASED ON UNRELATED CONSUMER ACTIVITY

(71) Applicant: Seth Priebatsch, Boston, MA (US)

(72) Inventor: Seth Priebatsch, Boston, MA (US)

(21) Appl. No.: 14/227,514

(22) Filed: Mar. 27, 2014

(51) Int. Cl. G06Q 30/02

(52) U.S. Cl. CPC G06Q 30/0267

(57) ABSTRACT

Transmission of a promotion is tied to actual performance of an activity. In various embodiments, that activity involves a consumer's use of a communication-capable application that transmits state information useful in timing the promotional outreach. “State” information can be used to trigger transmission to the consumer of a promotion from a merchant offering goods related to the activity.

### FIELD OF THE INVENTION

In various embodiments, the present invention relates generally to systems and methods for generating customized promotional offers for consumers in real-time.

### BACKGROUND

Merchants and suppliers often use promotional campaigns when marketing their products, to provide consumers or business customers with discounts or other incentives to purchase goods or services. Promotional campaigns include coupons, price reductions, buy-one-get-one-free promotions, contests, and the like. The objective of a sales promotion is to induce consumers to test or purchase products. Ideally, these efforts are directed toward the most profitable prospects: “high-yield” consumers most like to buy, and to do so in quantity. For example, a merchant might not want to waste a promotional offer on someone likely to try the product once, if at all, and never repeat the purchase; rather, merchants target consumers who exhibit habitual behavior.

Conventionally, merchants try to target consumers who fit key demographic and/or psychographic criteria that are indicative of a predisposition toward their products. Demographics can be basic characteristics such as sex, age, education and occupation, while psychographics can indicate a person's preferences and intentions. For example, a merchant may target women of age 25 to 45 for a new cosmetic product by placing a promotional offer, such as a coupon, in a women's magazine. Ultimately, however, the merchant may find the demographic to have been substantially overinclusive, reaching many women, and even men, who are unlikely to become repeat customers. Additionally, although psychographics are helpful in targeting consumers of products such as cigarettes, beer and cosmetics, the targeted consumers may not correlate well with demographic characteristics.

For many promotions, an important indicator of consumer interest is participation in activities that naturally relate to the target product. Campers, for example, purchase tents and gardeners buy fertilizer, so sellers may invest substantial resources in developing mailing or lead lists that identify consumers known to engage in activities closely correlated with the sellers' products. Such lists are expensive to assemble and may quickly become outdated. Moreover, they are not self-executing; contacting consumers is also expensive, and depending on the medium used, may not make a significant enough impression to motivate a sale. Gardeners are besieged by mailings from suppliers in late winter, for example.

Accordingly, what is needed is a mechanism for easily identifying consumers to whom a promotion is relevant and for transmitting that promotion to them at low cost and at times when they are most likely to be receptive.

### SUMMARY

The present invention provides an approach that ties transmission of a promotion to actual performance of an activity. In various embodiments, that activity involves a consumer's use of a communication-capable application that transmits state information useful in timing the promotional outreach. For example, a consumer may use a fitness application implemented as an “app” on a smart phone or other computational device. Fitness apps may store information for each user locally in an Internet-accessible database (i.e., “in the cloud”), often updating the online user records without the user's involvement (or even awareness) as she pursues fitness-related activities—noting, for example, when she has surpassed a previous personal record or achieved a predetermined goal. This “state” information (which can involve the occurrence of an event, such as achieving a goal, or one or more parameter values at a given time or upon the occurrence of a specified event, such as the end of a workout session) can be very useful both in targeting a fitness-oriented demographic as well as identifying times when the user is likely to be receptive to a promotional offer. The user's achievement of a personal cycling record, for example, can trigger a congratulatory promotion from a merchant offering discounts on cycling attire.

As another example of embodiments of the present invention, a consumer may use an application to manage a personal or family budget that generates and stores state information concerning the user's budgetary goals and progress toward such goals, including information specific to a user's desired and/or actual spending on various categories of goods or services. This state information about the user's establishment and/or achievement of such goals can trigger related promotions from merchants offering discounts on goods or services related to the user's budget, or that desire to target users matching certain economic criteria.

In still another exemplary embodiment, a consumer may use a travel-management application that generates and stores state information, including the consumer's booking and travel reservations, checks in for travel at terminal kiosks, and/or displays a boarding pass. This state information may trigger promotions from merchants located in the travel terminal and/or the destination location. These promotions can be offered in real-time, e.g., directly to the device running an app and/or directly to the user's mobile device if distinct from the device running the app. Embodiments of the present invention recognize the desirability of reaching targeted consumers at attractive times, and allow for bidding among promotion offerors for the privilege of directing a promotional offer to the consumer. The invention may, for example, be implemented as a fulfillment center that stores promotions uploaded by promotion offerors who have registered with the center, electronically distributing these offers to consumers in response to monitored consumer activity.

Accordingly, in a first aspect, the invention relates to a method of triggering an electronic communication to a user of an application executing as a running process on an appliance. In various embodiments, the method comprises the following steps, performed at a server: (i) storing, in a database, a plurality of records specifying applications, triggers and actions associated with the applications, and user devices; (ii) electronically receiving (e.g., from the appliance itself or from an application server in communication with the appliance) a signal indicative of a state of the appliance; (iii) determining whether the signal corresponds to a trigger stored in the database, and if so, identifying an action associated with the trigger; and (iv) electronically executing the identified action including transmitting data to the user device associated, in the database, with the appliance and/or a third-party server.

As used herein, the term “appliance” broadly connotes any apparatus capable of running an application and entering states relevant to the timing of promotional offers. In general, the appliance will be capable of communicating a state via the Internet, public telephone infrastructure, LAN, WAN, or other communication modality. The application may run entirely on the appliance, or may run primarily or in part on a remote server. For example, the appliance may be a piece of exercise equipment communicating with a server-resident hosting application that records fitness information for many users coming from many sources. The application or hosting application may be user-configurable, with goals, alerts and other events set by individual users. Occurrence of any of these events can serve as a trigger for purposes of the present invention, so that when an event is recorded, it is communicated to a server in accordance herewith. As noted, the server accesses a database having records specifying “applications, triggers, and actions.” The “applications” are typically those associated with an appliance and with which the server may communicate (i.e., either the appliance itself or, in the present example, the server-based hosting application). “Triggers” may determine whether a particular event—e.g., attainment of a goal—is sufficiently relevant to promotions management to merit an “action” such as, e.g., transmitting a promotion to the user or initiating an auction among offer providers. Typically, transmitting a promotion to the user means electronically sending it to a user device, which may be the appliance or the user's smart phone or tablet. In some cases, the smart phone or tablet is itself the appliance, whereas in other cases, they are separate devices (e.g., the appliance is a piece of exercise equipment and the user device is a smart phone). The user device or devices—where the user is most conveniently reached—may be stored in the database record associated with the application. The term “promotion” broadly connotes any offer or benefit conferred on the user, and whose redemption is or can be associated with the offer for tracking purposes (e.g., to monitor the effectiveness of the offer, the receptiveness to offers of a particular user or users of a particular appliance, etc.). A promotion may be negative, e.g., a reduction of a benefit or even a penalty in response to an action or its absence; for example, if the user of the fitness app skips her scheduled workout, she may be given an offer for 10% off on healthy food but suffer a 10% surcharge on sweets.

Transmitting data to one or more third parties generally involves alerting a server associated, in the database, with the action of the action's occurrence, e.g., providing data specifying the appliance state and identifying the user device. For example, third-party offer providers may sign up to receive alerts according to criteria that the providers specify. The third party may use the provided information to send an offer directly to the application user at the appliance and/or to a user device. In some cases, data is transmitted to multiple third parties and bids are received from some or all of them. In such cases, a winning bid is identified and a promotion associated with the winning bid may be transmitted to the user device associated, in the database, with the specified appliance. Revenue accruing to the fulfillment center vary depending on factors such as whether the offer is actually redeemed, whether the promotions offeror has specified presentation criteria associated with the promotion (e.g., whether or not the promotion should appear alongside competitors' promotions or ads), or if it has paid (or agreed to pay) a premium for exclusivity. The app publisher may also participate in the revenue stream, particularly if the app is reconfigured to accept promotions.

In other embodiments, promotions may be transmitted directly by the primary server. For example, the server may store eligible promotions or retrieve them from offer providers in real time when a triggering action occurs.

Performance, including redemption of promotions and other information, may be monitored over time and used to vary the actions and/or promotions. For example, actions may be monitored against corresponding metrics (e.g., a redemption frequency) over time and removed from the database if the metric is not achieved. Actions may be monitored on a per-user (or per-user-device) basis so that, over time, the system delivers promotions likely to be acted upon by a particular user; a learning or evolutionary algorithm may be used in such embodiments. Alternatively or in addition, the user may be permitted to specify criteria governing offers he will receive; these preferences may stored in the database and retrieved in order to filter eligible offers.

In a second aspect, the invention relates to server comprising an applications database for storing a plurality of records specifying applications, triggers and actions associated with the applications, and user devices; a communication module; and a processor configured to electronically receive, via the communication module, a signal indicative of the state of the appliance; query the applications database to determine whether the signal corresponds to a trigger, and if so, identify an action associated with the trigger; and electronically execute the identified action including causing transmission, via the communication module, of data to the user device associated, in the database, with the appliance and/or to a third-party server.

In some embodiments, the server further comprises or communicates with a promotions database for storing promotions. In such embodiments, the data may a promotion stored in the promotions database and the processor can be configured to cause transmission of the promotion to the user device associated, in the applications database, with the appliance.

The server may further comprise or communicate with a partner database specifying third-party servers associated with actions. In such embodiments, the data may specify the appliance state and identify the user device; the processor causes transmission of the data to the third-party server associated, in the partner database, with the action.

In some embodiments, the server further comprises an auction module for causing the processor to (i) receive, via the communication module, bids from a plurality of third-party servers that have received the data, (ii) identify a winning bid and (iii) cause transmission of a promotion associated with the winning bid to the user device associated, in the applications database, with the specified appliance.

The applications database may store performance metric values, in which case the processor may be configured to monitor the actions against the performance metrics, update the metric values, remove an action from the database in response to a metric value. The applications database may also store performance metric values, in which case the processor may be configured to monitor the actions against metrics with respect to a specific user device, and in response, to modify the data associated with the action.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 is a block diagram of an exemplary network in accordance with an embodiment of the invention;

FIG. 2 is a block diagram of an exemplary appliance in accordance with the present invention;

FIG. 3 is a block diagram of an exemplary application server in accordance with the present invention;

FIG. 4 is a block diagram of an exemplary promotion server in accordance with the present invention; and

FIG. 5 is a workflow diagram illustrating interactions that result in transmission of a promotional offer to a user in accordance with various embodiments of the invention.

### DETAILED DESCRIPTION

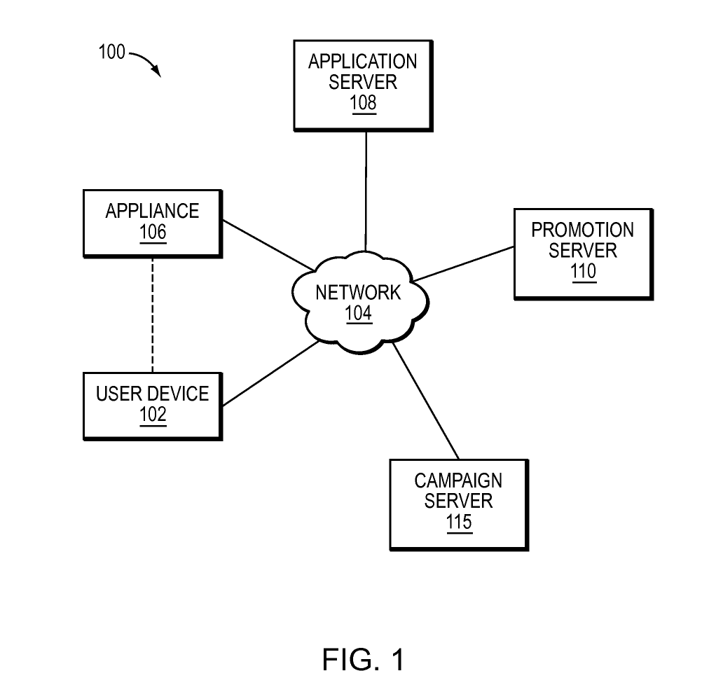

Refer first to FIG. 1, which depicts an exemplary mobile-payment transaction network 100 including a user device (e.g., a mobile device) 102 linked to other systems via a network 104 that supports wired, wireless, or any two-way communication (e.g., a cellular telephone network, the Internet, or any wide-area network or combination of networks capable of supporting point-to-point data transfer and communication). The network 104 connects various devices, including an appliance 106, an application server 108 that services an application run on the appliance 104, a promotion server 110, and one or more campaign servers 115, all as described in greater detail below.

The user device 102 is typically a mobile device such as a “smart phone” or tablet with advanced computing ability that, generally, facilitates bi-directional wireless communication and data transfer using a mobile telecommunication network, and is capable of executing locally stored applications. Mobile devices include, for example, IPHONES (available from Apple Inc., Cupertino, Calif.), BLACKBERRY devices (available from Research in Motion, Waterloo, Ontario, Canada), or any smart phones equipped with the ANDROID platform (available from Google Inc., Mountain View, Calif.), tablets, such as the IPAD and KINDLE FIRE, and personal digital assistants (PDAs). The memory 210 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit.

The appliance 106 may be a stand-alone device that locally runs an application communicating, via the network 104, with a service application running on the application server 108. The service application accepts data, commands and requests from the appliance 106. For example, the appliance 106 may be piece of exercise equipment configured for (e.g., wireless) communication with the application server 108. In that example, the service application may maintain a database record for each appliance user, and user data—e.g., heart rate and/or other physiological parameters, calories burned, maximum performance attained during a workout, etc. —uploaded from the appliance 106 during use thereof to the application server 108. The service application stores the received data in appropriate fields of the user's database record. More generally, the appliance 106 may be any communication-capable device associated with an activity and, typically, a remote service application that maintains user records associated with the activity. The user may access some or all of the stored records via a user interface generated by the application server 108 and accessible via the user device 102 or a computer, typically using the World Wide Web (the “web”), though such access is not required. The interface may permit the user to manage preferences—e.g., the type of data recorded and how it is presented when accessed, whether the user wishes to receive activity-related alerts, and the manner in which the user may be provided with promotional offers as described in greater detail below.

In other embodiments, the appliance 106 is the user device 102 running an app that performs similar functions, i.e., monitors a user activity and maintains local or remote user-specific records associated therewith. For example, the app may allow wine connoisseurs to scan a wine bottle's UPC barcode, obtain information (e.g., Robert Parker's rating, average retail price, etc.), and record personal impressions following consumption, thereby building a user-specific database of wines examined, purchased, consumed and rated for later lookup. This database may be local to the device 102 or remotely managed by an application server 108 with the records of other app users.

Each campaign server 115 is associated with an interested offer provider, such as a merchant who offers goods or services for sale to the consumer user of user device 102 or a third-party provider (e.g., the product manufacturer, advertiser, marketplace participant upstream from the merchant, or any party interested in providing promotional offers to the consumer). The campaign server 115 communicates with the promotion server 110 and, in response to appliance state information received from the promotion server or directly from the application server 108 (or appliance 106), may cause a promotional offer to be sent to the user—typically via the promotion server 110 or, following approval received from the promotion server, via the appliance 106 or directly to the user device 102 (depending on how much information the campaign server 115 has about the user).

The promotion server 110 may store promotions directly and, in response to a trigger as discussed below, may select one or more of the stored promotions and communicate it (directly or indirectly) to the appliance or device user. Alternatively, promotions may be obtained from the various campaign servers 115. For example, the promotion server 110 may communicate directly with offer providers to obtain the latest version of a promotion and/or to conduct an auction, as described in detail below.

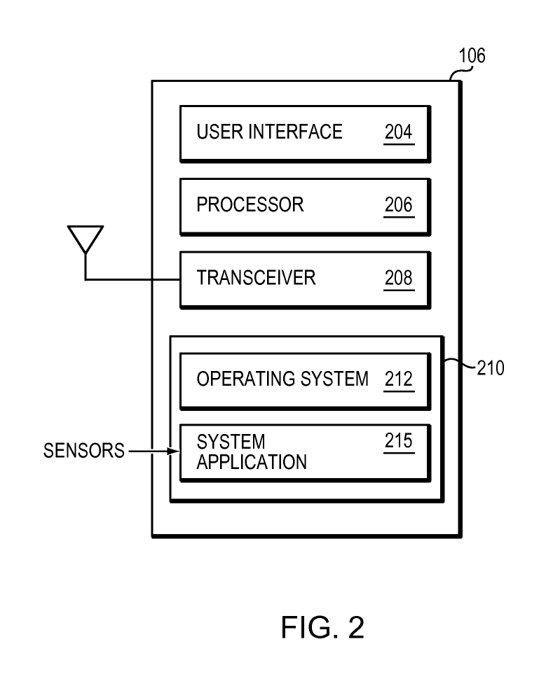

A representative appliance 106 is illustrated in FIG. 2. With reference to FIGS. 1 and 2, the appliance 106 includes, in various embodiments, a user interface 204, a processor 206, a transceiver 208, and a memory 210. The transceiver 208 may be a conventional component (e.g., a network interface or transceiver) designed to provide communications with a network, such as the Internet and/or any other land-based or wireless telecommunications network or system, and, through the network, with the promotion server 110 and/or the campaign server 115. The memory 210 includes an operating system (OS) 212, such as GOOGLE ANDROID, NOKIA SYMBIAN, BLACKBERRY RIM or MICROSOFT WINDOWS MOBILE, and a system application 215 that manages the functionality of the appliance 106. The system application 215 may generate the user interface 204 and enable the user to set operational parameters. For exemplary purposes, suppose that the appliance 106 is a stationary exercise bicycle and the system application 215 both controls the basic operation of the appliance 106 and gathers and transmits fitness data to the application server 108. The system application 215 may obtain readings from various sensors associated with the appliance (e.g., physiological parameters such as the user's heart rate, and performance parameters such as session time, distance covered, average and maximum speeds, calories burned, etc.) and cause these to be transmitted, via the transceiver 208, to the application server 108. As noted, in some embodiments the appliance 106 is actually the user device 102, in which case the system app 215 is one of perhaps many apps (which may include games, readers, a web browser, etc.) stored locally on the device 102.

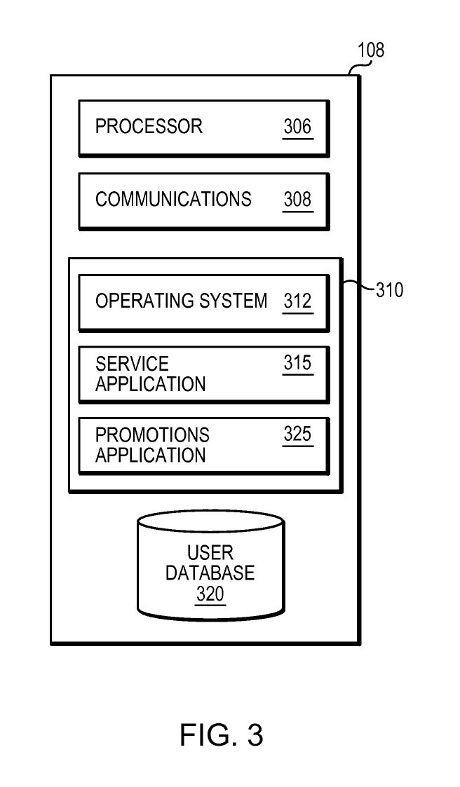

The application server 108—which may be maintained by, or run on behalf of, the supplier of the appliance 106—receives state data from the appliance on a periodic or event-driven basis. As illustrated in FIG. 3, a representative application server 108 also includes a processor 306, a communication module 308, and a memory 310 including an operating system 312 and a service application 315 that manages user data and communications with various appliances 106. The communication module 308 may be a conventional component (e.g., a network interface or transceiver) designed to provide communications with a network, such as the Internet and/or any other land-based or wireless telecommunications network or system, and, through the network, with the appliance 106.

The application server 108 also includes (or has access to) a user database 320, which maintains data for each registered user of an appliance 106. For example, at the conclusion of an exercise session, a stationary bicycle 106 may transmit data gathered during the session to the application server 108. The user has previously registered with the server 108, perhaps entering preferences for data she wishes to monitor and how the data is to be presented. Based on these preferences, the service application 315 stores all or some of the received data in a user database 320—in particular, in a record corresponding to the user. The user, in turn, may view recent performance parameters and trends by logging in to the application server 108 using, for example, her user device 102 or a computer. The user may also specify fitness goals, such as performance objectives and norms such as workout frequency, and the service application may monitor state information from the appliance 106 to determine when objectives have been attained or the user has deviated from a norm. The service application 315 generates a custom web page (using conventional webserver functionality) including user-specific data obtained from the user database 320 and formatted in accordance with the user's previously entered preferences, and causes this to be transmitted to the user via the communication module 308.

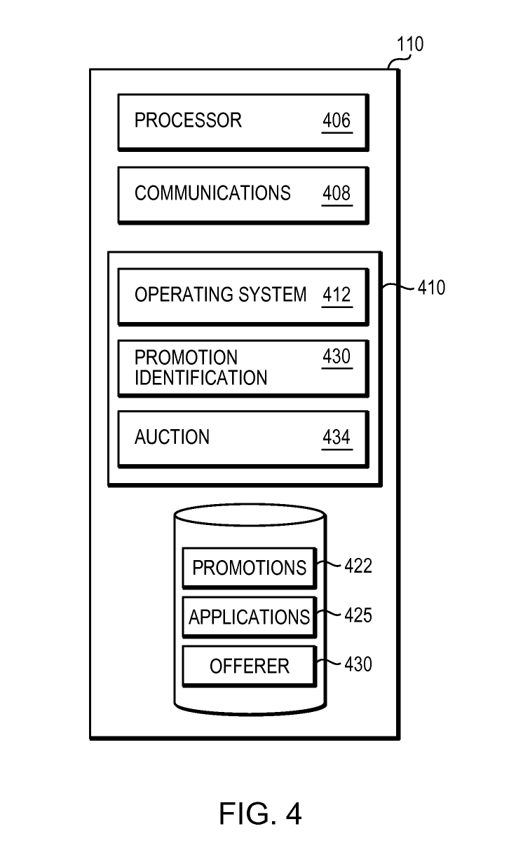

The memory 310 may also include a promotions application 325, which examines incoming user-specific data for matches to data types or events corresponding to promotion opportunities. The promotions application 325 is typically supplied on a third-party basis by a promotions-management entity, and may be installed on the application server 108 as a standalone process (as illustrated) with hooks into the service application 315 or as an embedded process within the service application. The promotions application 325 may also be hosted independent of the application server 108, but with access to the application server memory 310, user database 320, and/or an interface to the service application 315. The promotions application 325 causes all or some incoming user data to be transmitted to the promotion server 110, which is illustrated in greater detail in FIG. 4. The promotion server 110 includes processor 406, a communication module 408, and a memory 410 including an operating system 412. The promotion server 110 also includes or has access to a promotions database 422 and an applications database 425. The promotions database 422 includes promotions that may be delivered to users (typically via their mobile devices 102 and/or directly to the appliance 106). Offer providers may communicate with the promotion server 110 to upload new promotions to the promotions database 422 or to modify or remove existing promotions. The promotions may be in the form of coupons (e.g., documents formatted for display in a web browser of the user device 102), or may instead take the form of links to promotions stored on servers managed by the offer providers. In the latter case, the links may be followed by the promotion server 110 to obtain a promotion, or may instead be pushed directly to the user device 102 for viewing by the user. The promotions may also take the form of credit and/or discounts redeemable at a merchant's physical point of sale or at an online point of sale integral to a payment method utilizing the device 102 and/or an account established by the user with another application in communication with promotion server 110.

The applications database 425 stores records specifying applications, triggers and actions associated with the applications, and user devices 102. The contents of these records collectively determine when data from an appliance 106 employed by a particular user causes a promotion to be delivered to his user device 102. A trigger specifies whether state information from an appliance—e.g., an event such as attainment of a performance objective or deviation from habit or a stated norm—is sufficiently relevant to promotions management to merit an action. An action, in turn, may involve locating one or more promotions responsive to the trigger, transmitting it or them to the user, or initiating an auction among offer providers.

An offer provider registered with the promotion server 110 may supply promotions to the promotions database 422 and define promotional guidelines in the applications database 425. In particular, an offer provider may specify an application at any suitable level of granularity, e.g., by category (fitness), type of appliance (in-home exercise equipment) or even a particular device (a specified brand of exercise bicycle); one or more triggers associated with the application so defined; and promotions associated with the triggers. A promotion-identification module (“PIM”) 430, running on the promotions server 110, analyzes the offerors' guidelines to identify triggers falling within the specifications, and associates provider-specific actions with these triggers. In particular, the PIM 430 has logic that applies criteria entered by promotions offerors to applications fitting the criteria; for example, a promotions offeror that specifies “fitness applications” will activate triggers across more appliances than one specifying “stationary in-home exercise bicycles.” Similarly, specifying “attainment of a personal fitness objective” will potentially cover a broader range of events than “missing a workout session.” The ability of promotions offerors to control triggering criteria at a desired level of granularity allows them not only to avoid wasted resources (since they may be charged for each promotional offer provided to a user device) but also to select promotions in a more targeted fashion. A promotions offeror may also specify additional criteria characterizing target recipients of a promotion, e.g., traditional targeting criteria such as consumer demographics, transactional history, geographic proximity of the consumer to a location specified by the promotions offeror, weather conditions, etc.

In ordinary operation, the PIM 430 reviews information received from appliances 106 and/or application servers 108 to determine when a trigger stored in the applications database 425 is satisfied. Upon satisfaction of a trigger, the PIM 430 causes execution of the associated action. The promotions application 225 running on an application server 108 may be remotely addressable by the PIM 430 and modified in accordance with the triggers and actions stored in the applications database 425. For example, although numerous states of an appliance 106 are capable of being associated with triggers, only those triggers that actually correspond to actions in the database 425 are relevant to the operation of the PIM 430. Accordingly, the PIM 430 may remotely configure the promotions applications 225 of appliances 106 so that only relevant data is sent to the promotions server 110. For example, if no promotions offerors have registered promotions to be triggered by a particular event occurring on an appliance, then the promotions application running on the associated application server 108 will not waste bandwidth reporting the event to the promotions server 110.

In some embodiments, when a trigger is satisfied and the action specifies sending a particular promotion, the promotion server 110 obtains this from the promotions database 422 and sends it, via the communication module 408, to the user device 102 on behalf of the offer provider. In other embodiments, the offer is obtained by the promotion server 110 from the offer provider's campaign server 115 and is thereupon communicated, via the communication module 408, to the user device 102. In still other embodiments, the triggered action is not actually sending an offer but instead alerting one or more campaign servers 115 that the trigger has been satisfied, along with information sufficient to permit the server to communicate the promotion to the user. Offeror information may be stored in the promotions database 422 or in a separate offeror or partner database 430.

Whether a given promotion or set of qualifying promotions is actually sent to a user may depend on factors beyond matching of the trigger criteria. For example, an offer provider may agree to pay a premium for exclusivity, i.e., so that no other qualifying promotions will be sent alongside the exclusive provider's offer. The offer provider may also specify presentation criteria associated with a promotion (e.g., whether or not the promotion should appear alongside competitors' promotions or ads). Moreover, the offer provider may reserve the option of reviewing (in an automated fashion) qualifying offers before they are actually sent to the user; the offer provider may decide which of a plurality of qualifying offers to send, or to reject all of them.

In alternative embodiments, satisfaction of a trigger results in an auction among promotion providers. In particular, an auction module 434 supplies offer providers with the received state information and any additional data specified by offer providers to allow them to bid, in real-time, for the privilege of providing an offer to the user. In such embodiments, data indicative of the satisfied trigger, and optionally transactional and/or non-transactional data for the user, are transmitted to offer providers registered with the promotion server 110. Interested offer providers submit bids to the promotion server 110, which reflect how much they are willing to pay to have their offers presented to the particular user; this amount may be staged to reflect, for example, a first fee for transmission of the offer and a second fee if the user actually redeems the offer. The first fee can be tiered so that the offer provider has the option of bidding a higher amount for exclusivity, i.e., to preclude other offers from being simultaneously provided to the user. The auction module 434 assesses the bids as well as item-level and/or source-level conflicts (to prevent two offers for competing items from being simultaneously present to the user, for example, or alternatively, to search for and affirmatively provide competitive offers). In one embodiment, only the offer from the bid winner is transmitted to the user. In another embodiment, some or all offers are passed on to the user.

In various embodiments, the PIM 430 is configured to monitor performance over time and to use performance criteria to vary the actions and/or promotions. For example, the PIM 430 may monitor actions against corresponding metrics over time, and if the metric is not achieved (or achieved quickly enough), the action may be removed from the applications database 425. Metrics may include one or more of redemption frequency (i.e., how often the promotion is redeemed by a receiving user) or other measure of the likelihood of offer redemption, the success of a promotion in affecting a user's future purchases, benefits accruing to the user and/or the offer providers upon redemption, average spend on the first order following redemption, repeat visitation, and/or the size of any gratuity stimulated by redemption of the promotion. In various embodiments, the PIM 430 may monitor performance through communications from and/or to the user device 102 and/or through communications to other applications running on and/or associated with the user device 102, which may transmit data to PIM 430, or permit access to data by the PIM 430, about the redemption of the offers, promotions, coupons, and/or credit delivered to the user device 102.

Actions may be monitored on a per-user (or per-user-device) basis so that, over time, the system delivers promotions likely to be acted upon by a particular user, and at the optimal times; heuristics, or a conventional learning or evolutionary algorithm, may be used in such embodiments. Alternatively or in addition, the user herself may be permitted to specify criteria governing offers she will receive; these preferences may stored in the applications database 425 and retrieved by the PIM 430 in order to filter eligible offers. It should also be noted that a promotion need not be an offer and need not be delivered electronically; for example, the appliance supplier may derive publicity benefits from mailing branded attire to especially high-performing users.

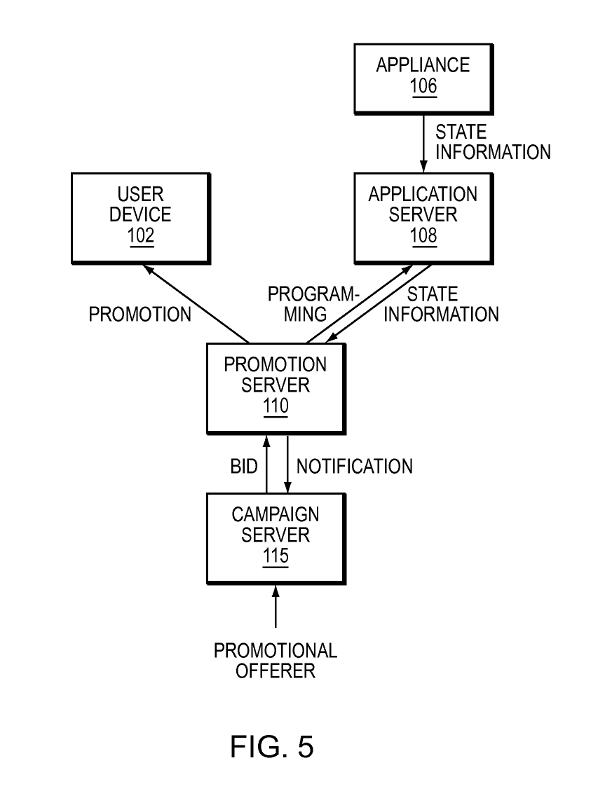

FIG. 5 illustrates a representative workflow in accordance with an embodiment hereof. A promotion offeror interested in providing promotional offers for goods or services to the user of an appliance may register an account with the promotion server 110 via its campaign server 115 to, for example, enable the promotion offeror to receive notifications of the appliance-specific trigger events in order to bid on sending a promotion to the user. The offeror may provide the promotion server 110 with its promotional guidelines specifying one or more triggering events and/or targeting characteristics (e.g., the user's transactional history, demographics, reviews or posts on social media sites, groups or clubs with which the consumer is associated, weather conditions, etc.) to define the specific circumstances in which it wishes to receive the notification—i.e., when the action associated with the trigger will actually be taken. The promotion server 110 locates appliances satisfying the offeror's criteria and remotely programs the associated application servers 108 to send appliance state data corresponding to the trigger.

When the promotion server 110 receives state information corresponding to the trigger, notification thereof along with any other offeror-requested data are provided to the promotion offeror, which, in turn, determines whether and how much it is willing to bid to have its offer communicated to the user based on the received information. The promotion (or a link thereto) may be provided along with the bid, or the promotion (or link) may be stored on the promotion server 110. Alternatively, the promotion may reside on the offeror's campaign server 115 to enable the offeror to change the terms of the offer at will in real-time. For example, the promotions database 422 (see FIG. 4) may store an Internet address associated with an offer, and when its criteria or rules are satisfied, the promotion server 110 retrieves the most current version of the offer from the campaign server 115 using the Internet address, and thereupon provides this offer to the user whose action caused the trigger to be satisfied.

The promotion server 110 determines one or more auction winners based on auction rules, which may include, for example, the bid, the discount amount offered, any item-level or seller-level conflict between the offers (e.g., offers for the same type of items from competing merchants), the likelihood of offer redemption, the likelihood of affecting the consumer's future purchases, benefits accruing to the user and/or the offer providers, the geographic proximity between the user and the offer providers, etc. For example, the promotions server 110 may track redemptions at a user level and, using an optimization algorithm, determine the characteristics of offers most likely to be redeemed by the user; based on this, the promotions server 110 may score the offers associated with bids in an auction and use this score in determining the winner.

The manner in which revenue is allocated among participants in the process is entirely flexible. In some embodiments, the offer provider pays a monthly fee in exchange for the promotion server 110 transmitting offers to users targeted as described herein. The fee paid by the offer provider may be based on, for example, the number of times offers are delivered to the user, the number of hits on the offers, the number of users who ultimately redeem the offer, the ranking of the offers, etc. Fees may be staged to reflect, for example, a first fee for transmission of the offer and a second fee if the user actually redeems the offer. The first fee can be tiered to increase if the offer provider requests exclusivity or other special handling or presentation of a promotion. Fees can also be shared to encourage participation; for example, the appliance supplier and/or manager of the application server 108 may receive a revenue component as an ongoing fee for incorporating the promotions app into the appliance and/or server, or may append a fee onto that charged to promotion providers by the manager of the promotion server 110.

It should be understood that the manner in which server functionality is distributed is arbitrary; the foregoing division among servers can be varied depending on commercial or technical considerations, and reference herein to a server can imply a plurality of servers, while reference to multiple servers can mean a single server. Similarly, the database configuration described above is exemplary only. It does not matter how the databases are divided or combined, nor is it critical which nodes they are most directly associated with so long as data examined or processed by anode is accessible thereto.

In the representative workflow depicted in FIG. 5, following a determination of the offeror(s) and offer(s), promotion(s), coupon(s), or credit(s) to be provided to the user, the promotion server 110 may transmit an offer or promotion directly to an appliance 108 running an app and/or directly to a user device 102, which may be the same device. Promotions or offers may be redeemed immediately through the app, by clicking a link or entering a code provided, or at a later time by displaying a document or code formatted for display in a web browser or application of the user device 102 at a merchant point of sale. The promotions may also take the form of credit and/or discounts redeemable at a merchant's physical point of sale or at an online point of sale integral to a payment method utilizing the device 102 and/or an account established by the user with another application in communication with promotion server 110.

Furthermore, promotions transmitted to users according to embodiments hereof, by the primary server or by third-party server, either to the appliance running the app or to a distinct user device or devices associated with the user, may be redeemed by the user independent of the appliance or app, and at a time after the user has ceased using the app, at a merchant's physical and/or online point of sale. The offering party may specify the conditions of future redemption of the promotion, including the period of the promotion's validity. For example, a user of a fitness app completing a cycling workout may be offered, through direct transmission to a user device, a discount on a health drink, from a merchant or third-party, that is redeemable at a physical point of sale location or locations within three hours following the completion of the workout. As another example, a user of a budget planning app who sets a goal for a limit on monthly spending for men's clothing may be offered a, through direct transmission to a user device, a discount from a clothing merchant or manufacturer redeemable at a physical point of sale location or locations for that month only. As another example, a person checking in for a flight at an airport kiosk may be offered a promotion for a discount at an airport terminal restaurant that expires at the time of the user's flight. Redemption of such promotions in accordance with various embodiments of the invention by a user using a user device may be performed integral to the user's payment for goods and services using the user device, or independent of such payment by displaying the offer or promotion on the user's device.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. Those skilled in the art will readily appreciate that all configurations described herein are meant to be exemplary and that the actual configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, and/or method described herein. In addition, any combination of two or more such features, systems, articles, and/or methods, if such features, systems, articles, and/or methods are not mutually inconsistent, is included within the inventive scope of the present disclosure.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. In addition, the terms like “user device,” “mobile,” “communication device,” and similar terminology, refer to a wireless device (e.g., cellular phone, smart phone, computer, PDA, set-top box, Internet Protocol Television (IPTV), electronic gaming device, printer, and so forth) utilized by a user of a wireless communication service to receive or convey data, control, voice, video, sound, gaming, or substantially any data-stream or signaling-stream. The foregoing terms are utilized interchangeably in the subject specification and related drawings. The terms “component,” “system,” “platform,” “module,” and the like refer broadly to a computer-related entity or an entity related to an operational machine with one or more specific functionalities. Such entities can be hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Each of the processors 206, 306, 406 that executes commands and instructions may be a general purpose computer, but may utilize any of a wide variety of other technologies including a special purpose computer, a microcomputer, minicomputer, mainframe computer, programmed microprocessor, micro-controller, peripheral integrated circuit element, a CSIC (customer-specific integrated circuit), ASIC (application-specific integrated circuit), a logic circuit, a digital signal processor, a programmable logic device, such as an FPGA (field-programmable gate array), PLD (programmable logic device), PLA (programmable logic array), RFID processor, smart chip, or any other device or arrangement of devices that is capable of implementing the steps of the processes of the invention.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, code or process) include machine instructions for a programmable processor, and can be implemented in a high-level procedural and/or object-oriented programming language, and/or in assembly/machine language.

The storage devices 310, 320, 410, 422, 425, 430 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the UNIX operating system, the LINUX operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

The storage devices may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The foregoing description does not represent an exhaustive list of all possible implementations consistent with this disclosure or of all possible variations of the implementations described. A number of implementations have been described.

Nevertheless, it will be understood that various modifications may be made without departing from the spirit and scope of the systems, devices, methods and techniques described herein. For example, various forms of the flows shown above may be used, with steps re-ordered, added, or removed. Accordingly, other implementations are within the scope of the following claims.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of triggering an electronic communication to a user of an application executing as a running process on an appliance, the method comprising the steps of, at a server:
storing, in a database in communication with the server, a plurality of records specifying applications, trigger actions or states associated with the applications, and user devices;
electronically receiving at the server from an application executing as a running process on an appliance remote from the server, information indicative of a state of the appliance or application executing thereon;
determining whether the received information corresponds to a trigger stored in the database associated with a record, and if so, identifying an action associated with the trigger;
electronically executing the identified action including transmitting data to at least one of (i) the user device associated, in the database, with the appliance or (ii) a third-party server.

2. The method of claim 1, wherein the appliance and the user device are the same device.

3. The method of claim 1, wherein the appliance and the user device are different devices.

4. The method of claim 1, wherein the data is a promotion transmitted to the user device associated, in the database, with the specified appliance.

5. The method of claim 1 wherein the data is transmitted to at least one third-party server associated, in the database, with the action, the data specifying the appliance state and identifying the user device.

6. The method of claim 5, further comprising transmitting, by at least one third-party server to the user device associated, in the database, with the specified appliance, at least one promotional offer responsive to the appliance state.

7. The method of claim 5, further comprising receiving bids from a plurality of third-party servers that have received the data.

8. The method of claim 7, further comprising identifying a winning bid and causing transmission of a promotion associated with the winning bid to the user device associated, in the database, with the specified appliance.

9. The method of claim 1, further comprising monitoring the actions against corresponding metrics over time and removing an action from the database if the metric is not achieved.

10. The method of claim 1, further comprising monitoring the actions against corresponding metrics over time with respect to a specific user device, and in response, modifying the data associated with the action.

11. The method of claim 4, wherein the data is a plurality of promotions.

12. The method of claim 4, wherein the data is a single promotion selected from among a plurality of eligible promotional offers in response to an exclusivity payment from a sponsor of the selected promotion.

13. The method of claim 4, wherein the data is one or more promotions selected from among a plurality of eligible promotional offers based at least in part on criteria electronically specified by the user.

14. A server comprising:
an applications database for storing a plurality of records specifying applications, triggers and actions associated with the applications, and user devices;
a communication module;
and a processor configured to:
electronically receive, via the communication module, from an application executing as a running process on an appliance remote from the server, information indicative of the state of the appliance or the application executing thereon;
query the applications database to (i) determine whether the received information corresponds to a trigger associated with a record, and if so, (ii) identify an action associated with the trigger; and
electronically execute the identified action including causing transmission, via the communication module, of data to at least one of (i) the user device associated, in the database, with the appliance or (ii) a third-party server.

15. The server of claim 14, further comprising a promotions database for storing promotions, wherein (i) the data is a promotion stored in the promotions database and (ii) the processor causes transmission of the promotion to the user device associated, in the applications database, with the appliance.

16. The server of claim 14, further comprising a partner database specifying third-party servers associated with actions, wherein (i) the data specifies the appliance state and identifies the user device and (ii) the processor causes transmission of the data to the third-party server associated, in the partner database, with the action.

17. The server of claim 14, further comprising an auction module for causing the processor to (i) receive, via the communication module, bids from a plurality of third-party servers that have received the data, (ii) identify a winning bid and (iii) cause transmission of a promotion associated with the winning bid to the user device associated, in the applications database, with the specified appliance.

18. The server of claim 14, wherein the applications database also stores performance metric values, the processor being further configured to monitor the actions against performance metrics, update the metric values, remove an action from the database in response to a metric value.

19. The server of claim 14, wherein the applications database also stores performance metric values, the processor being further configured to monitor the actions against metrics with respect to a specific user device, and in response, to modify the data associated with the action.

20. The server of claim 15, wherein the data is a plurality of promotions.

21. The server of claim 15, wherein the data is a single promotion selected from among a plurality of eligible promotional offers in response to an exclusivity payment from a sponsor of the selected promotion.

22. The server of claim 15, wherein the data is one or more promotions selected from among a plurality of eligible promotional offers based at least in part on criteria electronically specified by the user and stored in the promotions database.

23. A system for triggering an communication of electronic promotion data to a user of an application executing as a running process on an appliance, the system comprising:
an appliance; and
a server in communication with the appliance, the server comprising:
an applications database comprising information concerning application users; application activity; promotional data; and
promotion trigger information;
a communication module; and
a processor configured to:
electronically receive, via the communication module, from an application executing as a running process on an appliance remote from the server, information indicative of the state of the appliance or the application executing thereon;
query the applications database to (i) determine whether the received information corresponds to a trigger associated with a record, and if so, (ii) identify a promotion associated with the trigger; and
electronically execute the identified action by causing transmission, via the communication module, of promotion data to at least one of (i) a user device associated, in the database, with the appliance or (ii) a third-party server

24. The system of claim 23, wherein the appliance and the user device are different devices.

25. The system of claim 23, wherein the data is a promotion transmitted to the user device associated, in the database, with the information received from the specified appliance.

26. The system of claim 25, wherein the data is one or more promotions selected from among a plurality of eligible promotional offers based at least in part on criteria electronically specified by the user.

27. The system of claim 23, further comprising a partner database in communication with the server specifying third-party servers associated with actions, wherein (i) the data specifies the appliance state and identifies the user device and (ii) the processor causes transmission of the data to the third-party server associated, in the partner database, with the action.

28. The system of claim 27, wherein the server further comprises an auction module for causing the processor to (i) receive, via the communication module, bids from a plurality of third-party servers that have received the data, (ii) identify a winning bid and (iii) cause transmission of a promotion associated with the winning bid to the user device associated, in the applications database, with the specified appliance.

29. The system of claim 23 further comprising a merchant point-of-sale device in communication with the server, and wherein the promotion data transmitted from the server to the user device comprises a promotion redeemable automatically by communicating said data from the user device to the merchant point-of-sale device.
